(19) United States
(12) Patent Application Publication
(10) Pub. No.: US 2013/0268296 A1
(43) Pub. Date: Oct. 10, 2013

(54) METHOD AND APPARATUS FOR IDENTIFYING, MONITORING AND TREATING MEDICAL SIGNS AND SYMPTOMS

(71) Applicant: M-3 Information LLC, Rockville, MD (US)

(72) Inventors: Michael L. BYER, Gaithersburg, MD (US); Bernard M. SNYDER, Bethesda, MD (US)

(21) Appl. No.: 13/829,282

(22) Filed: Mar. 14, 2013

Related U.S. Application Data
(63) Continuation-in-part of application No. 11/543,058, filed on Oct. 5, 2006.
Application No. 11/543,058 is a division of application No. 10/429,736, filed on May 6, 2003, now abandoned.

(51) Int. Cl. G06F 19/00

(52) U.S. Cl. CPC G06F 19/3431
USPC 705/3

(57) ABSTRACT

A system for identifying and monitoring risk of a plurality of predefined mental health disorders in a single composite score is provided. The system includes a network portal providing access to at least one patient and at least one health care provider; a patient symptom inventory including a grouped, listing of questions corresponding to a plurality of mental symptoms; and a patient assessment progress record including an assessment record for tracking the patient's risk of suffering from the plurality of potential mental conditions over time. The system receives patient responses to the patient symptom inventory and determines, based on the patient selected responses, a composite score indicating the extent to which the plurality of mental symptoms impairs the patient's functioning and individual risk assessments indicating the likelihood the patient is suffering from each of the plurality of potential mental conditions.

This application is a continuation-in-part of co-pending U.S. application Ser. No. 11/543,058 filed on Oct. 5, 2006.

### COPYRIGHT RESERVATION

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention relates to medical signs and/or symptoms. More particularly the present invention relates, for example, to identifying, monitoring and treating the medical signs and/or symptoms of mental illness (e.g., depression, anxiety, PTSD and bipolar disorder).

### BACKGROUND

Epidemiological studies repeatedly provide evidence, for example, for a considerable incidence of major depression, anxiety disorders, and/or bipolar mood disorders (manic depressive illness) in the general population. At the same time, a disappointingly small percentage of people are properly treated for their symptoms and/or condition.

Recent data suggest some twenty-five percent of women and ten percent of men in the United States will have major depression at some point in their lives. Yet only forty percent of individuals with a major depression will receive treatment and in only fifteen percent of instances is it of adequate dose and duration. The World Health Organization indicates that depression is the number one ranked illness for causing disability, ahead of heart attacks, strokes, and cancer. Bipolar illness is the number six cause of disability.

The consequences of untreated depression go well beyond its associated suffering, disability, and potential for suicide. Untreated depression is a high risk factor for cardiovascular diseases, for example, as well as chronic pain syndromes. Individuals who are depressed are two to four times more likely to suffer from a heart attack than those not depressed and further are two to four times more likely to die of a heart attack.

As another example, the incidence of chronic pain syndromes is directly proportional to the number of depressive symptoms. Those people with major depression are far more likely to suffer from a chronic pain syndrome than those without. Even difficulty stopping smoking is highly associated with a history of depression and anxiety syndromes.

Yet while many physicians are aware of these statistics, depression all too often falls off the medical agenda in a time-pressured medical visit. A person's symptoms and/or condition such as, for example, depression and/or associated anxiety symptoms should be recognized and treated.

### SUMMARY

This specification describes technologies relating to systems and methods for identifying and monitoring risk of a plurality of predefined mental health disorders in a single composite score.

In general, one aspect of the subject matter described in this specification can be embodied in a system for identifying and monitoring risk of a plurality of predefined mental health disorders in a single composite score that includes a portal providing access to doctors and patients, a patient symptom inventory including a predetermined, grouped, listing of questions corresponding to a plurality of mental symptoms related to a plurality of potential mental conditions, and a patient assessment progress record including an assessment record for tracking the patient's risk of suffering from the plurality of potential mental conditions over time. The system is further configured to receive patient responses to the patient symptom inventory and determine, based on the patient selected responses, a composite score indicating the extent to which the plurality of mental symptoms impairs the patient's functioning and individual risk assessments indicating the likelihood the patient is suffering from each of the plurality of potential mental conditions

These and other embodiments can optionally include one or more of the following features. The patient symptom inventory further includes a plurality of patient selectable responses, for each of the listed questions, indicating an occurrence frequency from within a frequency range. Further, the system may receive, via the portal, a health care provider's notes on a patient's progress and update the appropriate patient assessment progress record.

### BRIEF DESCRIPTION OF THE DRAWINGS

In the drawings, like reference numerals represent similar parts of the illustrated embodiments of the present invention through the several views and wherein:

FIG. 1 is one embodiment of an apparatus;

FIG. 2 is another embodiment of the apparatus of FIG. 1;

FIG. 3 is one embodiment of a method to monitor and treat, for example, signs, symptoms and/or side effects;

FIG. 4 is another embodiment of an apparatus;

FIG. 5 is an exemplary patient symptom inventory according to an embodiment of the invention; and

FIG. 6 is a patient assessment progress report according to an embodiment of the invention.

### DETAILED DESCRIPTION

For example, use of a self-screening instrument may circumvent the problem identified above, as the self-recognition of symptoms may be presented to a physician and/or clinician for evaluation and condition diagnosis. One embodiment of an apparatus (e.g. a form) may include, for example, a screening instrument such as, for example a patient checklist of pertinent symptoms.

The screening instrument may be a self-rating device, which may facilitate the discussion to treat these symptoms in an otherwise busy medical practice where discussion of other medical symptoms may be the main focus. The self-rating device may also benefit individuals by allowing them ample opportunity to ponder and respond without encumbrances from health care providers presence, which may generate discomfort and/or uneasiness leading to confused, unconsciously withheld, consciously suppressed (e.g., suppressed for fear of embarrassment) and/or miscommunicated information (e.g., medical and/or biographical information). The self-rating device further confers decision-making empowerment to individuals.

The apparatus may also include an overview (e.g., a brief overview) of available medications and a follow-up instrument on symptom improvement and/or possible side effects. The apparatus may aid in enhancing treatment initiation, monitoring, and/or possible side effects. The apparatus may aid in enhancing treatment initiation, monitoring, and/or maintaining long term improvement in this undeserved domain of general medical practice.

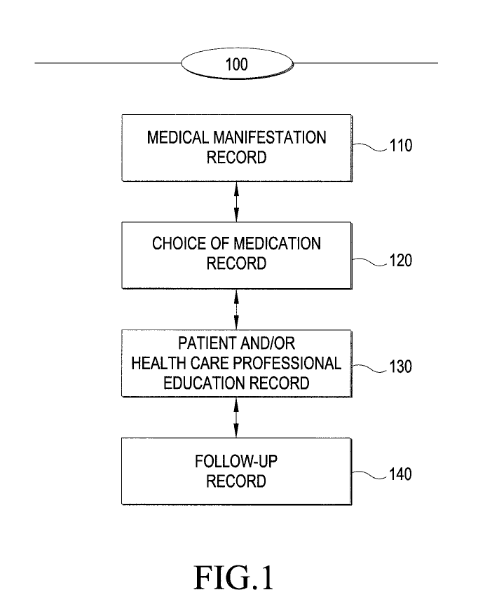

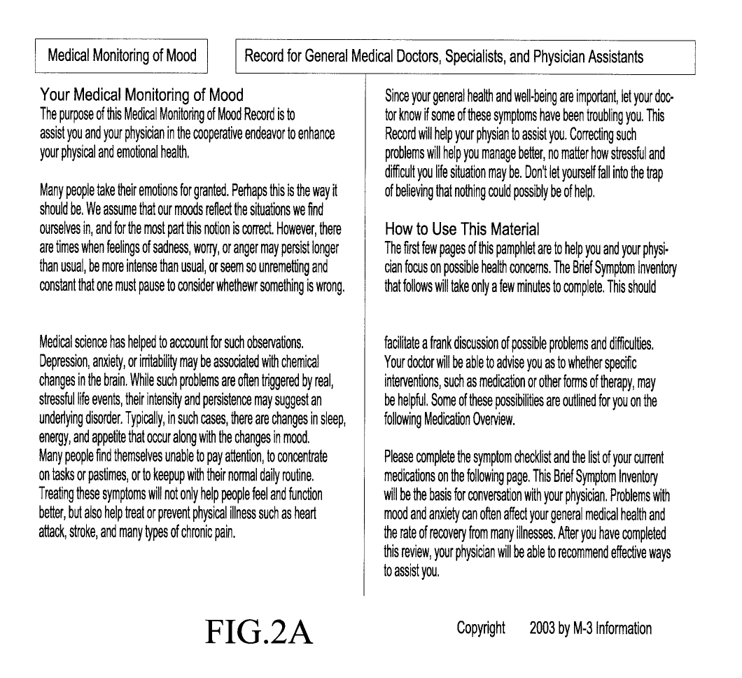

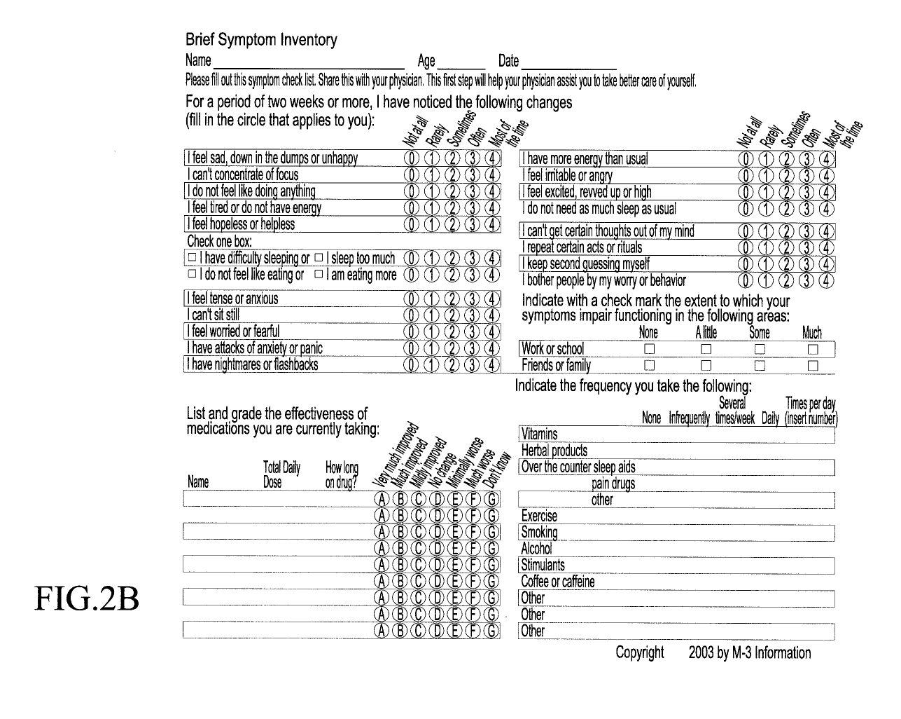

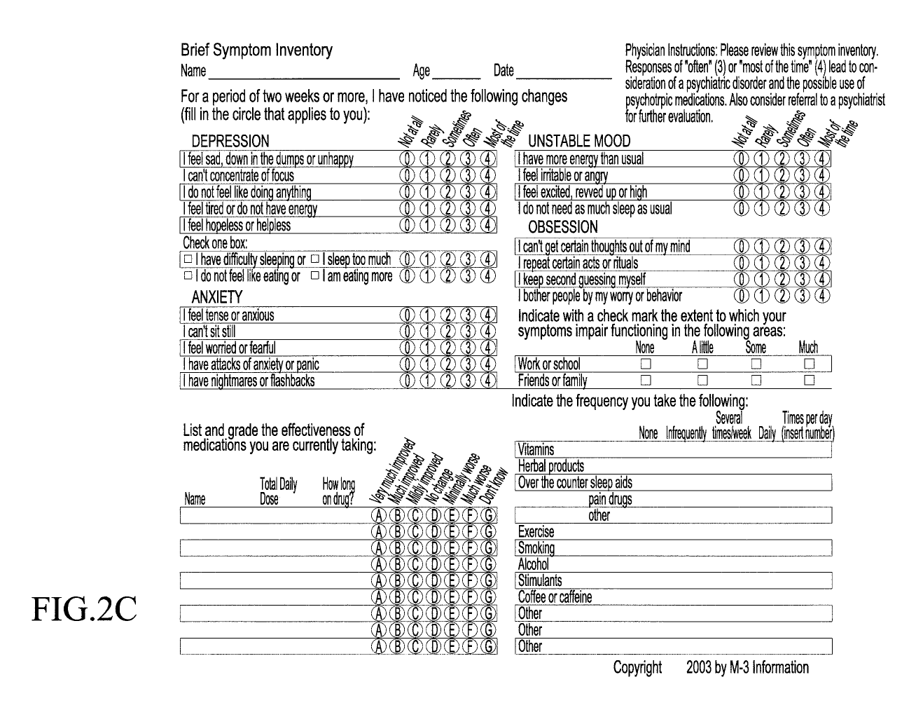

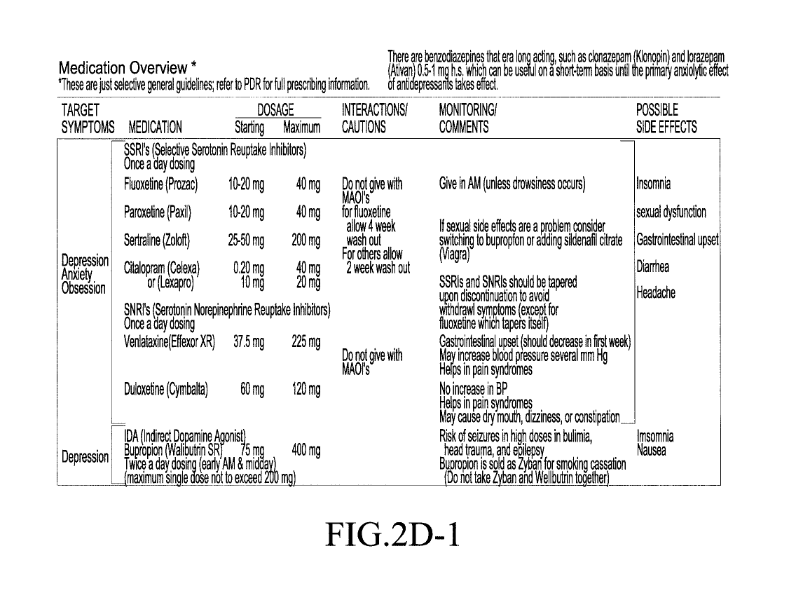

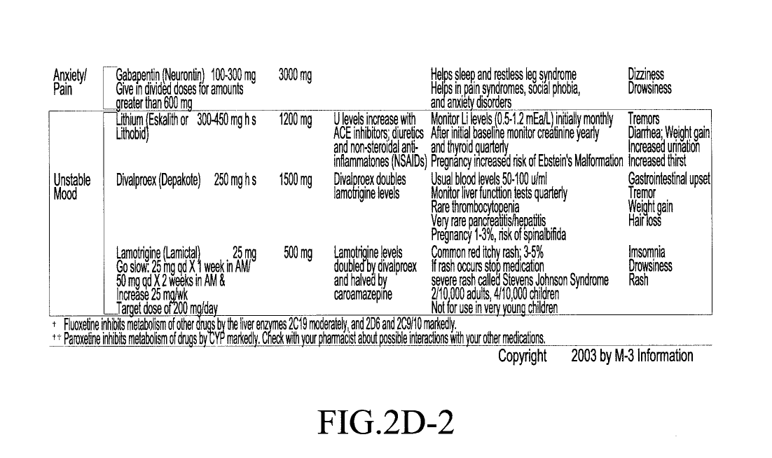

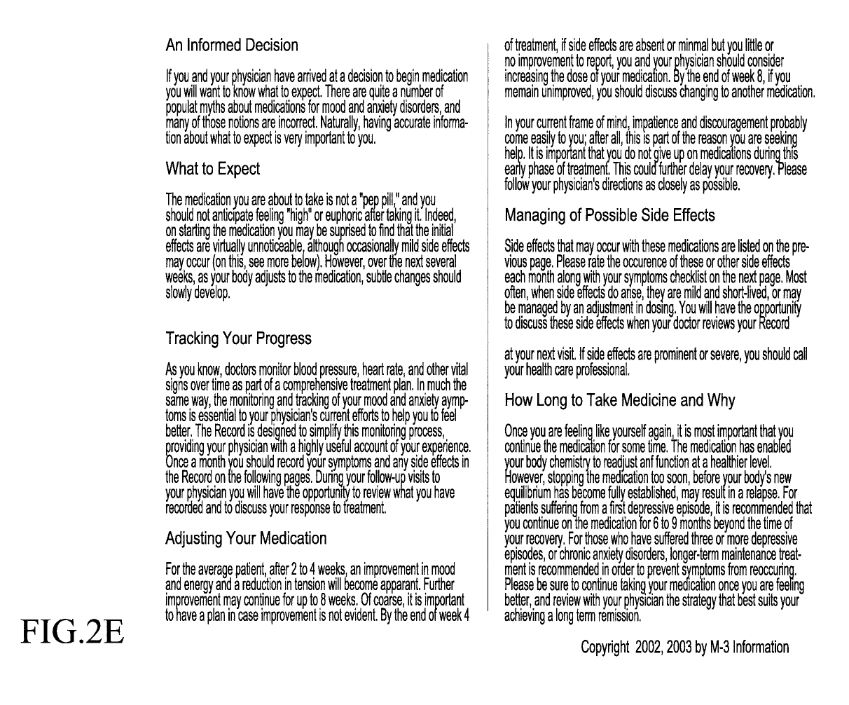

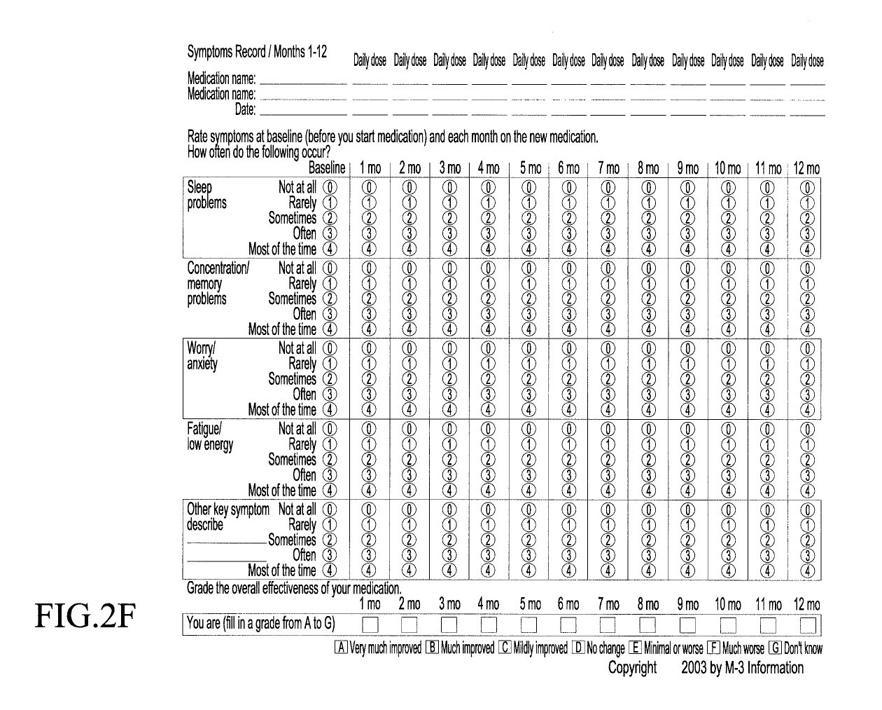

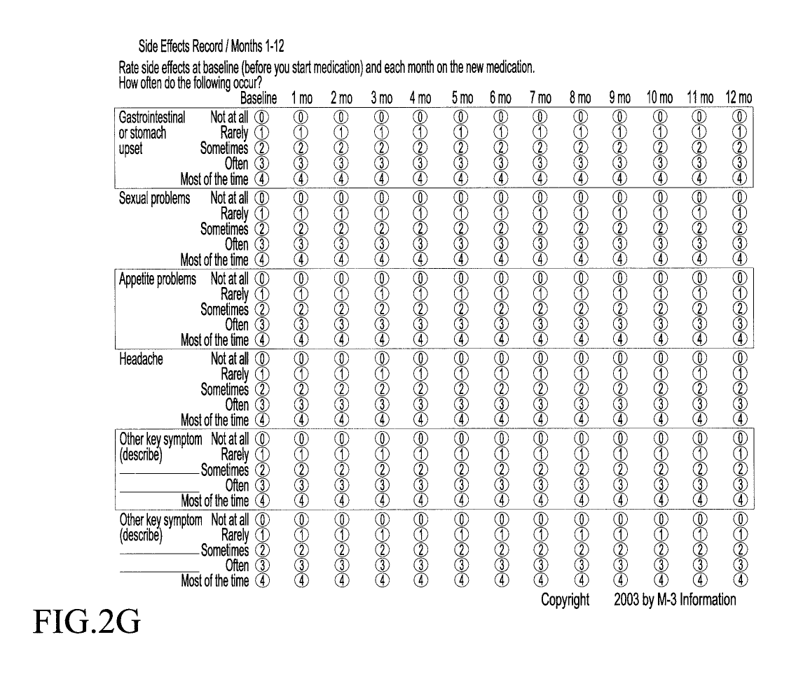

FIG. 1 illustrates one exemplary embodiment of an apparatus 100, which may include (i) a medical manifestation record 110, (ii) a choice of medication record 120, (iii) a patient and/or health care professional education record 130 and/or (iv) a follow-up record 140, for example, to monitor symptoms and/or side effects. The apparatus 100 may be a form such as, for example, a hardcopy form and/or an electronic form. FIG. 2 illustrates another exemplary embodiment of the apparatus 100.

### Medical Manifestation Record 110

A symptom inventory may identify, for example, one or more medical signs and/or symptoms, one or more medication side effects, one or more medications, one or more foods, one or more beverages, and/or one or more activities. The symptom inventory may include one or more lists (e.g., check lists). The symptom inventory may also include symptoms associated with depressive and/or anxiety disorders such as, for example, bipolar illness and obsessive compulsive disorder. For example, depression in the elderly is highly prevalent, yet often missed in primary care visits. The symptom inventory may ask about prior times when an individual may have experienced a symptom to determine a history of one or more symptoms which may facilitate a diagnosis. The extent of one or more medical signs, medical symptoms, and/or medication side effects associated with an individual may be identified through one or more marks (e.g., check marks).

The symptom inventory may include a patient worksheet and/or a healthcare professional worksheet. The patient worksheet may identify a plurality of medical signs and/or symptoms and/or not a plurality of causes of the plurality of medical signs and/or symptoms. The healthcare professional worksheet may identify the plurality of medical signs and/or symptoms and/or the plurality of causes of the plurality of medical signs and/or symptoms. For example, a plurality of medical categories (e.g., a plurality of causes of the plurality of medical signs and/or symptoms) (i) may not be revealed to the individual via the patient worksheet and/or (ii) may be revealed to a healthcare professional via the healthcare professional worksheet. The plurality of medical categories may include depression, anxiety, unstable mood, and/or obsession.

### Choice of Medication Record 120

The apparatus may include a list (e.g., a one-page list) of medications (e.g., common drugs), their doses, and/or common side effects. These medications may be grouped into several general categories. The medications may include vitamins, herbal products, supplements (e.g., nutritional supplements), over-the-counter medications, and/or prescription medications. The apparatus may establish, in part or in whole, one or more medications that alleviate the one or more medical signs, medical symptoms, and/or medication side effects associated with the individual. The apparatus may also include at least one of (i) one or more uses, (ii) directions, (iii) ingredients, (iv) features, (v) forms, (vi) one or more labels, (vii) warnings, (viii) cautions, and (ix) side effects associated with the medications.

Patient and/or Health Care Professional Education Record 130

The apparatus may include information associated with at least one of (i) what to expect from a medication, (ii) tracking medical progress, (iii) adjusting the medication, (iv) managing medication side effects, and (v) how long to take the medication and why (see, for example, FIG. 2).

### Follow-up Record 140

If a decision is reached to treat the symptoms and/or signs, the apparatus may provide an easy framework for the patent and/or clinician to monitor symptom relief and/or the emergence (or not) of any side effects that might occur on a regular basis. At least the extent of one or more medical signs, medical symptoms, and/or medication side effects associated with a person may be recorded through the follow-up record 140 at least one of (i) daily, (ii) weekly, (iii) bi-weekly, and (iv) monthly for a period of at least one of (i) one or more days, (ii) one or more weeks, (iii) one or more months, and (iv) one or more years. Based on the progress and/or emergence or not of side effects, for example, indicated on the follow-up record 140, the necessary adjustment in a therapeutic approach may be made.

The apparatus may include a year's worth of monthly ratings, for example, as it is recommended that depressed patients continue on medication for six to nine months after they have recovered from their depressive episode. An extended period of monitoring may decrease the incidence of relapse compared to early termination of the drug(s) as is a common mode of treatment in the United States where the need for continuation of treatment has not been widely promulgated or accepted. It is conventional thinking that it is demonstration of strength to stop medications and weakness to continue on them, despite the very considerable suffering, disability, and increased medical risk that a recurrence might engender. The apparatus may educate patients, for example, about the treatment, and may encourage them to continue with the treatment (e.g., psychotropic medication treatment) through a recommended time period.

Contributing factors to inadequate continuation in treatment include lack of information and substantial stigma, for example, about psychiatric illness and their treatment. In addition to the general stigma about psychiatric illness and its appropriate treatment is the recent spate of reports and newspaper articles questioning the acute efficacy of antidepressants. What these articles all fail to discuss is that depression is an episodic illness making short term comparison with placebos difficult. High relapse rates also occur following discontinuation of antidepressants or adjusting depression medication in the elderly. In addition, if one stays on the antidepressants for a longer term there is unequivocal evidence of their ability to prevent future recurrences. For example, the general rule of thumb endorsed by scientific and academic bodies suggests that after three prior major depressions the individual should strongly consider long-term maintenance treatment to prevent further recurrences.

Several medical analogies may also be helpful, for example, in fostering understanding of the need for long-term maintenance treatment in those with a number of prior depressive recurrences. Treatment of high blood pressure with medications for months to years does not reverse the basic defect, and one requires long term maintenance treatment in this regard. Similarly with digitalis which increases the strength of contractility of the heart (important in the treatment and prevention of congestive heart failure), one would never try out the experiment of discontinuing digitalis and seeing whether a patient, friend, or relative went into irreversible congestive heart failure and pulmonary edema. Yet this is exactly the experiment that many depressed patients try on themselves. Not only does this increase the risk of depressive occurrence, but with each successive depression, there is a further ten percent risk of chronicity that the depressive episode is not amenable to treatment.

This range of data, for example, on the under recognition, misdiagnosis, under treatment and relatively high recurrence rates of untreated depression and bipolar disorder have long been known. The situation, however, may change, for example, in view that information now indicates that antidepressants may protect brain functioning as well as cell survival and generation of new neurons and can counter the effects of stress. One may be able to help change from the exclusive view that the antidepressants are medicines with side effects and are potentially dangerous to the view that they may have medical and life-saving benefits and also help protect the brain and facilitate the growth of new neurons. In addition, another factor is also the increasing recognition that depression is a powerful risk factor for the occurrence of many other medical illnesses and a prognostic factor in their ultimate positive outcome.

The apparatus may be structured to put a premium on patient participation and/or reliance on patient monitoring of symptoms and/or medication side effects in order to minimize the time requirements for physicians and/or other clinical and medical staff.

Even in a minimalistic form, the apparatus is useful. Moreover, if other more detailed evaluations and/or rating instruments are required, they may be added to the apparatus. The apparatus may be a diagnostic instrument, although it may not substitute for careful clinical evaluation and discussion. At the same time, the apparatus provides a convenient, readily accessible combination of symptom inventory and/or record of treatment follow-up that should prove of great assistance to the patient with symptoms and/or medical difficulties.

Patients often present co-morbid mood and anxiety symptoms, subsyndromal illnesses, co-morbid substance abuse, and/or co-morbid physical symptoms. These overlapping symptoms may not reach criteria for a diagnosis for any disorder when analyzed by themselves. However, taken as a whole, these cases typically represent patients in need of mental health treatment. In one embodiment of the invention, an exemplary apparatus may include information that is less diagnosis-centric and more dimensional in its approach.

### Patient Symptom Inventory

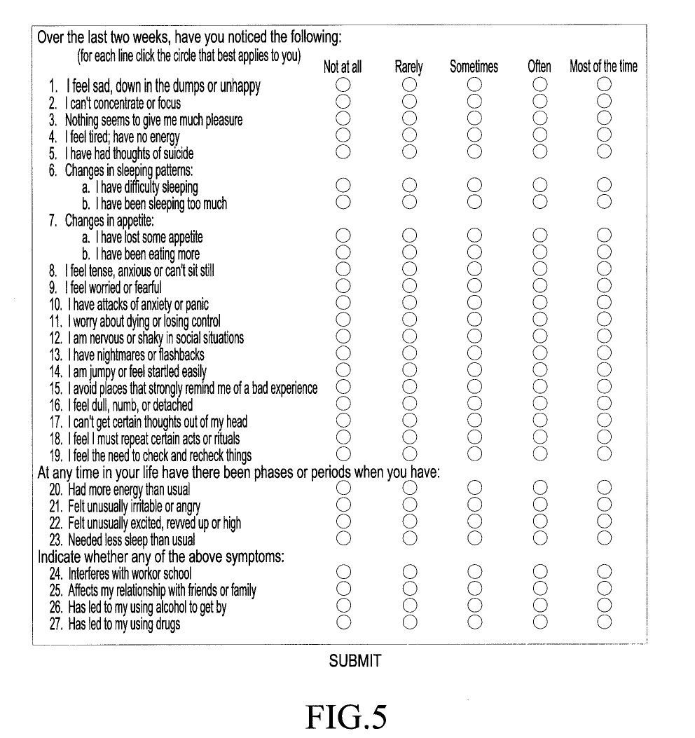

In addition to the patient information obtainable using the apparatus of FIG. 2, the patient may be provide a simple patient symptom inventor as illustrated in FIG. 5 which includes a predetermined, grouped, listing of questions corresponding to a plurality of mental symptoms related to a plurality of potential mental conditions, for example, depression, anxiety, and post-traumatic stress disorder (PTSD). As illustrated in FIG. 5, each question includes a plurality of selectable responses indicating an occurrence frequency from within a defined frequency ranges, for example, a two week period.

### Composite Score

The apparatus may provide a single composite measurement, for example, an overall score, which reflects the patient's overall need for treatment. This composite score numerically represents a measure of functional impairment and/or substance use patterns. Additionally, the apparatus may include information regarding individual risk assessments, for example, in the form of a scale from low to high, for specific syndromes such as depression, anxiety, PTSD, and bipolar disorder which make up the composite score. The composite score and/or individual risk assessments may be determined based on a patient's response to patient symptom inventory.

### Patient Assessment Progress Report for Physician

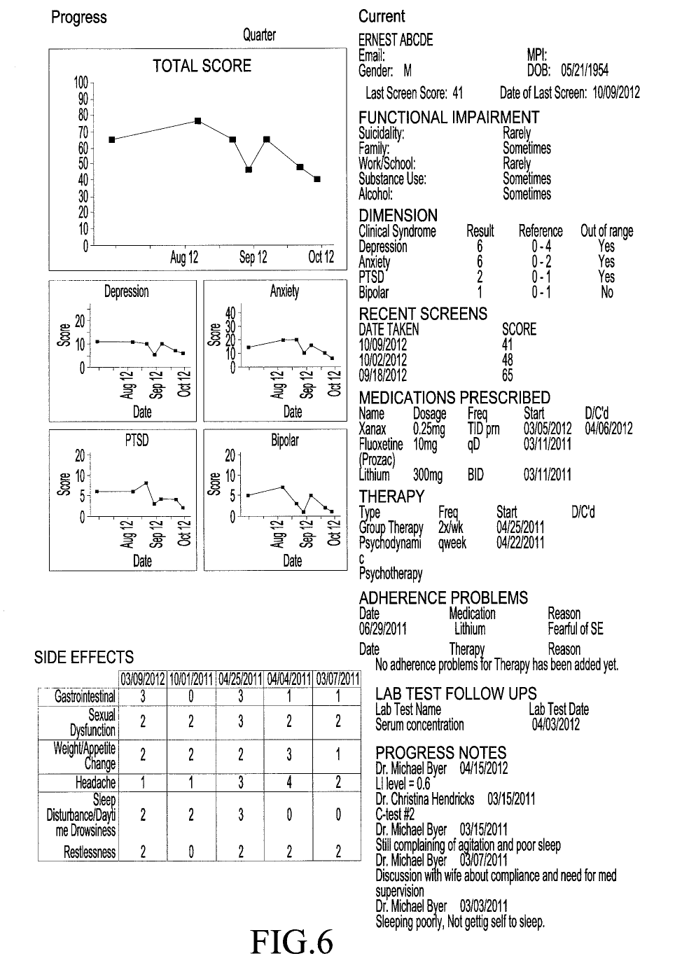

In an exemplary embodiment, an apparatus may combine the information discussed above across a patient's screenings over a given period of time to provide a comprehensive patient assessment progress report, herein “progress report”, for example as shown in FIG. 6.

The progress report may contain the patient's personal information including: the patient's name, email address, gender, date of birth, master patient index, the patient's last screening date, and the patient's last screening score.

The progress report may additionally contain information regarding the functional impairment of the patient. Functional impairment may include: the frequency of suicidal thoughts; the frequency of family issues impairing the patient; the regularity with which work or school impacts the patient's ability to function; the occurrences of substance abuse; and the patient's alcohol use.

The progress report may also show the patient's dimensions for clinical syndromes. For each syndrome, the apparatus may provide a risk assessment for the patient based on the patient assessment and the reference point for the syndrome. There may also be information to indicate whether the patient's result is out of the normal range for the syndrome. Example syndromes may be depression, anxiety, PTSD, and bipolar disorder.

The progress report apparatus may contain information regarding the patient's previous screenings. Patient screenings may be filtered and displayed by date. The progress report may show all of the patient's screenings or may show recent patient screenings based on a date range. Information regarding previous patient screenings may include the date on which the patient screening was taken and the composite score associated with each screening.

In addition to written information regarding the patient's previous screenings, the progress assessment report may contain graphical representations, for example, a histogram, bar or other type of graph, of previous screening results. This representation may show the patient's composite scores over time in order to reflect the patient's overall need for treatment. Although the composite score is useful, the progress report may also include visual representations for the individual syndrome risk assessments over time.

The progress report may also include information about the prescribed treatments plan, for example, medications and/or therapy in order to provide a quick reference for a physician and/or patient to determine the effectiveness of the current treatment plan. More specifically, the patient assessment progress report may include information regarding the medications prescribed to the patient for a given date range. The report may show the name of each medication, the dosage, the frequency, and the start date and stop date of the medication. The exemplary apparatus may also include information about the patient's therapy. The report may display the type of each therapy in which the patient is or has participated over a given time period. The frequency as well as the start date and end date of each therapy may be given.

The progress report may include information regarding adherence problems to medication or therapy. Adherence problems may include the date of each problem, the type of problem, and a reason for the problem.

In addition to adherence problems, the exemplary apparatus may discuss the side effects that the patient is experiencing along with the date and frequency of the side effects.

The progress report may include information regarding lab tests and follow-ups to these tests. The apparatus may also have progress notes, along with a date for each note, from clinicians, nurses, doctors, or other people regarding the patient.

Information from the patient assessment progress report may help with diagnosis, medication dosages, therapy recommendations, and overall assessment of the patient's progress over a given time period.

### Medications

Presently, the healthcare industry distributes medications through a two-class system, prescriptions and nonprescriptions. When a drug becomes classified as a nonprescription, the medication is made available for direct use by consumers. Presently, a variety of prescription drugs have become readily available as nonprescription drugs. The American Pharmaceutical Association reports that in 1998 consumers spent approximately $17 billion in purchasing over-the-counter medications. As the use of nonprescription medication increases, concerns about self-prescription and patient safety have also increased.

People have a misconception that they do not need to be as careful when taking over-the-counter medications because they can take them without a doctor's prescription. That assumption can pose a serious threat to a person's health. Potential risks are involved with taking medication, whether prescriptions and/or nonprescriptions such as, for example, interaction with other medications, foods, beverages, and/or medical conditions. In 1998, more than one-fourth of all hospitalizations were the result of adverse drug events, costing the healthcare industry $76 billion annually.

The wide variety of products available can be overwhelming to any person trying to determine the medication for a particular medical condition. With the extensive and rapidly increasing medications available today, it has even become difficult for healthcare providers to be aware of all the drugs and their generic equivalents, interactions, and/or side effects. The fact is that concerns, for example, about self-prescription and/or patient safety are real.

One embodiment of a method (e.g. automated method) is provided to simplify choosing a medication treatment that is safe and effective for a person (see, for example, FIGS. 1-3). The method also allows a patient and/or a healthcare professional to be informed on the medication they will be prescribing and/or taking. The method may provide the patient with questions relating to symptoms so as to establish a disorder (e.g., a preliminary disorder) and/or the medication treatment based, in part or in whole, on answers provided by the patient to the questions.

An exemplary method may present information identifying a plurality of medical signs, medical symptoms, and/or medication side effects. The method may ask a person (e.g. a patient) a plurality of questions (e.g. diagnostic questions) associated with medical signs, symptoms, and/or side effects. The questions may be answered, through oral and/or non-oral communication, with a “yes” and/or “no” response. The questions may also be designed to elicit, through oral and/or non-oral communication, a numeric response, where the numeric response relates to a frequency at which the person is experiencing medical signs, symptoms, and/or side effects. The questions may elicit information associated with the person such as, for example, age, weight, height, sex, allergies, current conditions, relevant family and/or medical history, prescribing physician, and/or dispensing pharmacy.

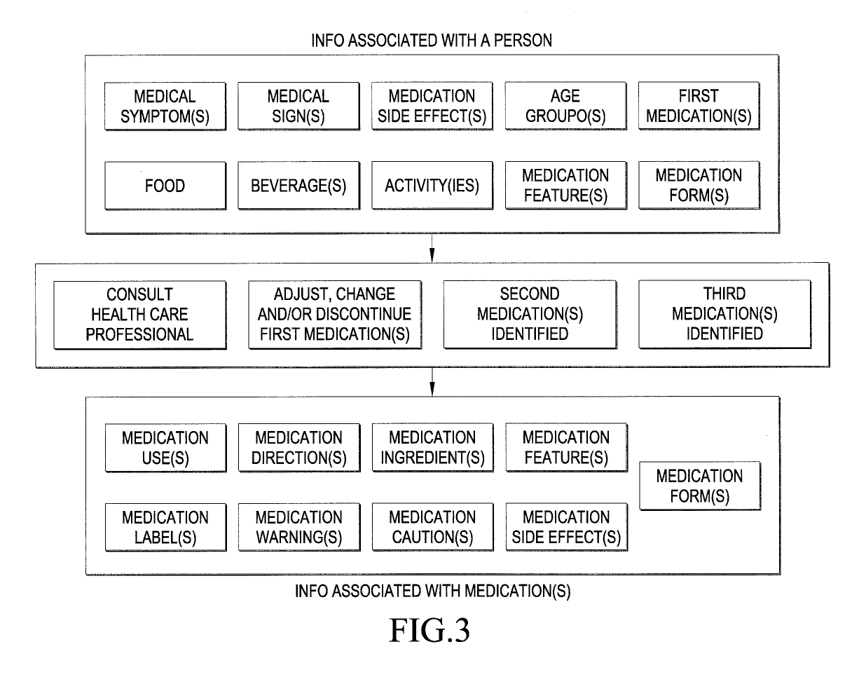

The method may designate and/or record, through the person's answers to the questions, at least one of (i) one or more medical signs, medical symptoms, and/or medication side effects, for example, from the plurality of medical signs, medical symptoms, and/or medication side effects, (ii) on or more first medications (e.g., a medication remedy), (iii) one or more foods, (iv) one or more beverages, (v) one or more activities, (vi) one or more medication forms, and (vii) one or more groups (e.g., one or more age groups) (see, for example, FIG. 3). The one or more activities may include exercising, smoking, driving a motor vehicle, operating machinery, and/or soaking sunlight. The one or more medication forms may include a pill, a spray, a drop, a cream, a lotion, a tablet, a caplet, a liquid, a gelcap, and/or a capsule, The one or more groups may include child (e.g., children under 6 and/or 12 years of age), adult, pregnant, and/or older adult.

One or more of the person's answers may be designated through at least one of (i) pressing a first button, (ii) clicking a second button, (iii) touching a screen, (iv) oral and/non-oral communication, (v) one or more forms (e.g., hardcopy and/or electronic form), (vi) one or more marks (e.g., checkmarks), and (vii) one or more lists (e.g., a checklist). The extent of one or more medical signs, medical symptoms, and/or medication side effects associated with the person may be designated for a period of one or more days, one or more weeks, one or more months, and/or one or more years (see, for example, FIG. 2).

The information may be designated and/or recorded while a patient is being interviewed and/or from medical records taken by a healthcare professional during an examination. The method may also obtain information from an individual through automated interactive interview and/or a self-rating questionnaire.

The one or more medical signs, medical symptoms, and/or medication side effects may be grouped under a plurality of medical categories (see, for example, FIG. 2). The one or more medical signs, medical symptoms, medication side effects, and/or medical categories may be associated with a physical, emotional, and/or mental condition, depression, anxiety, unstable mood, obsession, cardiovascular, diabetes, gastrointestinal, infection, migraine, ophthalmic, pain and/or arthritis, respiratory, urologic disorders, women's health, headache, convulsion and/or seizure, chest pain, heatstroke, tremor, dizziness, irregular heartbeat, fainting, shortness of breath, chest injury, head injury, cough, croup, high blood pressure, hyperventilation, numbness, wheezing, allergies, inhalation injury, and/or strokes. The one or more medical signs and/or symptoms may also be associated with sleep problems, concentration and/or memory problems, worry, anxiety, fatigue, and/or low energy. The one or more medication side effects may also be associated with gastrointestinal and/or stomach upset, sexual problems, appetite problems, and/or headaches.

The method may identify (e.g., automatically identify) one or more second medications that at least one of (i) alleviates the one or more medical signs, medical symptoms, and/or medication side effects, (ii) does not interact with the one or more first medications, the one or more foods, and/or the one or more beverages, (iii) can be taken without avoiding the one or more activities, (iv) comes in the one or more medication forms and (v) can be used by the one or more groups. The one or more second medications may be identified without the need to seek the advice of a healthcare professional and/or without the need to read a medication label. The method may purchase, through a pharmacy, a store (e.g., a supermarket) and/or a service (e.g., an online service), the one or more second medications.

The method may also identify (e.g., automatically identify) whether to (i) consult a healthcare professional and/or (ii) take, adjust, change, and/or discontinue a medication remedy (e.g., the one or more first and/or second medications) associated with a person depending in whole or in part, upon the extent of the one or more medical signs, medical symptoms, and/or medication side effects associated with the person. Depending on the answers, the person may be told to contact a pharmacist, a nurse and/or doctor, and/or be given an appointment to be examined.

The method may further present (e.g., automatically and/or through the one or more forms) information associated with at least one of (i) the one or more second medications and (ii) one or more third medications, both of which may alleviate the one or more medical signs, medical symptoms, and/or medication side effects associated with the person. The information associated with the one or more second and/or third medications may be identified, through hyperlinks, for linking and/or reviewing.

The information associated with the one or more second and/or third medications may include at least one of (i) medication use, (ii) medication directions (e.g., dosage, frequency, and/or duration), (iii) medication ingredients, (iv) medication features (e.g., regular and/or extended release), (v) medication forms, (vi) medication label, (vii) medication warnings, (viii) medication cautions, and (ix) medication side effects. The information associated with the one or more second and/or third medications may include at least one of (i) who should not take the one or more second and/or third medications, (ii) other medications that may interact with the one or more second and/or third medications, (iii) side effects associated with the one or more second and/or third medications, (iv) foods and/or beverages to avoid while taking the one or more second and/or third medications, and (v) activities to avoid while take the one or more second and/or third medications.

Medications may have a synergistic effect with other drugs, foods, and/or beverages. For example, the bioflavonoid constitutes in grapefruit juice may cause clinically significant drug interactions. Herbal products may contain numerous pharmacologically active constituents that potentially participate in herb-drug interactions. Also, many people take decongestants as they battle colds. If these people have high blood pressure, they should not take the decongestants, which may cause blood pressure to rise.

The method may then select the one or more second and/or third medications depending, in part or in whole, upon the information associated with at least one of (i) the one or more second medications and (ii) the one or more third medications.

The one or more second medications, for example, may treat individual symptoms, whereas the one or more third medications, for example, may treat a combination of symptoms. If the person only has a subset of the possible symptoms (e.g. a cough, but not a stuffy or runny nose), the individual symptoms may be treated with the one or more second medications, rather than take a combination medication and treat symptoms the person does not have. Also, the person may not get enough of a particular active ingredient when taking a combination product and/or may overdose on an ingredient if a combination medication is taken in conjunction with another drug. If the person has multiple symptoms, the person may be treated with a combination of medications.

The one or more first, second, and/or third medications may include at least one of (i) vitamins, (ii) herbal products, (iii) supplements (e.g., nutritional supplements), (iv) an over-the-counter medication, and (v) a prescription medication. A side effect and/or dose associated with the one or more first, second, and/or third medications may also be identified (e.g., automatically identified). The one or more first, second, and/or third medications may be identified through a trade name and/or generic name.

Another exemplary method may present information identifying a plurality of patient screening results, medications prescribed, therapies attended, adherence problems encountered, side effects experienced, lab test results, and/or progress notes regarding the patient in order for healthcare professionals to effectively treat a patient. The method begins with receiving patient information. Received information may include information such as personal information, functional impairment, clinical syndrome dimensions, recent screens, medications prescribed, therapy sessions, adherence problems, side effects, lab tests, and progress notes. Information from individual screening events may be received and combined with other information to provide a healthcare professional with a comprehensive view of the patient's diagnosis, treatments, and progress. Using the received patient screening results, the method may combine screening results to display the patient's checklist scores across time. The combined screening results may be displayed to a healthcare professional using text and/or a visual representation such as a histogram or another type of graphical representation. The method may also combine information regarding individual scores for specific syndromes across time. Like screening results, syndrome information may be visually represented using a graphical representation. The method additionally may aggregate information regarding medications prescribed, therapies attended, adherence problems encountered, side effects experienced, lab test results, and/or progress notes over a specified time period. Each type of information may then be displayed on a distinct area of a form so that a healthcare professional may easily view the aggregate information to see the patient's progress and use the information to make an informed decision regarding a patient's course of treatment.

The exemplary methods may provide information in different languages and/or translate information from one language to another. For example, English language text and information may be translated to Spanish to permit Spanish-speaking individuals to effectively use the method.

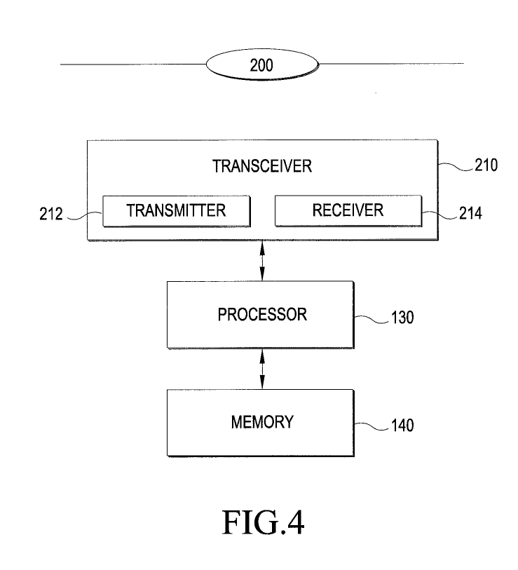

FIG. 4 illustrates one implementation of a machine 200, for example, configured to effect the described embodiments. The machine 200 may include a computer such as, for example, a server, a laptop, a desktop, and/or handheld computer. The machine 200 may also include a display device and/or a printer. The machine 200 further includes a transceiver 210, a processor 220, and a memory 230. The transceiver 210 may include a transmitter 212 that may transmit information, for example, to a network (not shown) over a communications link (not shown), the display device and/or the printer. The network may include a wide area network (WAN) (e.g., Internet), or a local area network (LAN) (e.g., Intranet), or the like, where the communications link may be a direct land line, or a radio communications link, such as a microwave link, satellite link, or the like. The transceiver 210 may also include a receiver 214 that may receive information, for example, from the network over the communications link. Such transmission and reception operations over the communications link may be conducted using the same or different data rates, communications protocols, carrier frequencies, and/or modulation schemes. Likewise, the operations and/or circuit configurations of the transmitter 212 and the receiver 214, respectively, may be completely independent of one another or, alternatively, may be partially or fully integrated.

The processor 220, which may comprise one or more microprocessors, microcontrollers, and/or other arrays of logic elements, may control the operation of the machine 200 according to a sequence of commands that may be (i) stored in the memory 230 and/or in another storage device within or coupled to the machine 200, (ii) entered by a user through an interface such as a data entry device (e.g., a keypad, touch screen and/or speech recognition interface) (not shown), and/or (iii) received from the network over the communications link.

The memory 230, which may comprise read-only memory (ROM), random-access memory (RAM), nonvolatile memory, an optical disk, a magnetic tape, and/or magnetic disk, stores programmable parameters and may also store information including executable instructions, non-programmable parameters, and/or other data.

The memory 230 may store the medical manifestation record 110, the choice of medication record 120, the patient and/or health care professional education record 130 and/or the follow-up record 140. The memory 230 may also store information associated with medical signs, medical symptoms and/or medication side effects, medications, foods, beverages, activities, medication forms and/or groups (see, for example, FIG. 3). The memory 230 may further store information associated with medication use, medication directions, medication ingredients, medication features, medication labels, medication warnings, medication cautions and medication side effects (see, for example, FIG. 3).

The memory 230 may be within and/or coupled to the machine 200. Executable instructions defining a method associated with the presented embodiments may also be stored in the memory 230 for execution by the processor 220. The method may be programmed when the machine 200 is manufactured or via a machine-readable medium at a later date. Such a medium may include any of the forms listed above with respect to the memory 230 and may further include, for example, a carrier wave modulated, or otherwise manipulated, to convey instructions that can be read, demodulated/decoded and executed by the machine 200.

The machine 200 may be accessible to at least a customer and/or a member associated with a pharmacy, a store and/or a service (e.g., an online service). The machine 200 may also be located in the pharmacy, the store and/or the service, and may used by at least the customer and/or the member.

In sum, the described embodiments may facilitate treatment and/or follow-up, and may indicate whenever more comprehensive evaluation and/or exploration of range of options may be needed. Referral and/or consultation may be indicated whenever treatment does not progress as expected or there is an acute risk of harm, for example, by suicide. Referral for therapy in addition to medications may also be valuable. The apparatus may include a self-rated instrument that facilitates the treatment of symptoms, enhances a patient's overall medical health and/or reduces considerable risk factors for the onset of a series of other major medical illnesses.

In view of the foregoing, it will be apparent to one of ordinary skill in the art that the described embodiments may be implemented in software, firmware, and/or hardware. The actual software code or specialized control hardware used to implement the present invention is not limiting of the invention. Thus, the operation and behavior of the embodiments is described without specific reference to the actual software code or specialized hardware components. The absence of such specific references is feasible because it is clearly understood that artisans of ordinary skill would be able to design software and/or control hardware to implement the embodiments of the present invention based on the description herein.

The foregoing presentation of the described embodiments is provided to enable any person skilled in the art to make or use the present invention. Various modifications to these embodiments are possible, and the generic principles presented herein may be applied to other embodiments as well. For example, the invention may be implemented part or in whole as a hard-wired circuit, as a circuit configuration fabricated into an application-specific integrated circuit, or as a firmware program loaded into non-volatile memory or a software program loaded from or into a data storage medium as machine readable code, such code being instructions executable by an array of logic elements such as a microprocessor or other digital signal processing unit, or some other programmable machine or system. As such, the present invention is not intended to be limited to the embodiments shown above, any particular sequence of instructions, and/or any particular configuration of hardware but rather is to be accorded the widest scope consistent with the principles and novel features disclosed in any fashion herein.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A system for identifying and monitoring risk of a plurality of predefined mental health disorders in a single composite score, the system comprising:
a network portal providing access to at least one patient and at least one health care provider;
a patient symptom inventory including a predetermined, grouped, listing of questions corresponding to a plurality of mental symptoms related to a plurality of potential mental conditions, each question having a plurality of patient selectable responses indicating an occurrence frequency from within a frequency range;
a patient assessment progress record including an assessment record for tracking the patient's risk of suffering from the plurality of potential mental conditions over time, a treatment plan record for tracking the patient's treatment plan over time; and a side effect record for tracking the extent of side effects of the patient's medications over time; and
one or more processors configured to
display the patient symptom inventory to a patient via the portal;
receive the patient selected response to each of the listed questions;
determine, based on the patient selected responses, a composite score indicating the extent to which the plurality of mental symptoms impairs the patient's functioning and individual risk assessments indicating the likelihood the patient is suffering from each of the plurality of potential mental conditions;
update the patient assessment progress record with the acquired and determine information; and
provide, via the portal, a patient assessment progress report that includes a visual representation of the patient's composite scores and individual risk assessments over a predefined time period, a summary of the patient's functional impairment; and a summary of the patient's treatment plan.

2. The system of claim 1, wherein the one or more processors are further configured to receive, via the portal, a health care provider's notes on a patient's progress and update the appropriate patient assessment progress record.

3. The system of claim 1, wherein the patient assessment progress record is updated at least one of (i) daily, (ii) weekly, (iii) bi-weekly and (iv) monthly for a period of at least one of (i) one or more days, ii) one or more weeks, (iii) one or more months and (iv) one or more years.

4. The system of claim 1, wherein the treatment plan record includes a medication record that tracks one more medications, including dosage and frequency, taken by the patient.

5. The system of claim 4, wherein the one or more medications includes at least one of (i) a vitamin, (ii) a herbal product, (iii) a supplement, (iv) an over-the-counter medication and (v) a prescription medication.

6. The system of claim 5, wherein the side effect record includes one or more side effects automatically identified as being associated with one or more of the medications contained in the patient's medication record.

7. The system of claim 6, wherein the one or more processors are further configured to receive, from the patient, an indication of the extent to which the patient is suffering from one or more side effects and to update the patient's side effect record accordingly.

8. The system of claim 1, wherein the one or more processors are further configured to receive, from a health care provider, information identifying a treatment plan for the patient, the treatment plan including prescription of at least one of medication and therapy.

9. The system of claim 1, wherein the treatment plan record includes a choice of treatment record, for use by a health care professional, the choice of treatment record being automatically generated by the one or more processors based on the patient selected responses and revealing the individual risk assessment that the patient suffers each of the plurality of potential mental conditions to assist the health care provider in treating the patient and prevent misdiagnosis.
